(19) United States
(12) Patent Application Publication
(10) Pub. No.: US 2025/0249920 A1
(43) Pub. Date: Aug. 7, 2025

(54) INFORMATION PRESENTATION DEVICE

(71) Applicant: SUBARU CORPORATION, Tokyo (JP)

(72) Inventor: Kentaro SHIGEOKA, Tokyo (JP)

(21) Appl. No.: 18/986,864

(22) Filed: Dec. 19, 2024

(30) Foreign Application Priority Data
Feb. 7, 2024 (JP) 2024-017265

(51) Int. Cl. B60W 50/14; B60Q 3/70; B60Q 3/80; B60R 1/24

(52) U.S. Cl. CPC B60W 50/14; B60Q 3/731; B60Q 3/80; B60R 1/24; B60R 2300/50; B60R 2300/8093; B60W 2050/143; B60W 2050/146

(57) ABSTRACT

An information presentation device includes a light emitter, a static three-dimensional object detector, and an information presentation controller. The light emitter is disposed in front of a driver's seat and includes light emission areas arranged along a width direction of a vehicle. The static three-dimensional object detector is configured to detect static three-dimensional objects ahead of the vehicle. The information presentation controller is configured to flash the light emission areas corresponding to positions of the static three-dimensional objects sequentially from a far side to a near side.

### CROSS-REFERENCE TO RELATED APPLICATIONS

The present application claims priority from Japanese Patent Application No. 2024-017265 filed on Feb. 7, 2024, the entire contents of which are hereby incorporated by reference.

### BACKGROUND

The disclosure relates to an information presentation device.

There has been proposed a vehicle including a light emission display provided in front of a driver who drives the vehicle along a width direction of the vehicle (e.g., Japanese Unexamined Patent Application Publication No. 2016-197407). This vehicle flashes an area of the light emission display corresponding to a direction of a moving object ahead of the vehicle.

### SUMMARY

An aspect of the disclosure provides an information presentation device. The information presentation device includes a light emitter, a static three-dimensional object detector, and an information presentation controller. The light emitter is disposed in front of a driver's seat and includes light emission areas arranged along a width direction of a vehicle. The static three-dimensional object detector is configured to detect static three-dimensional objects ahead of the vehicle. The information presentation controller is configured to flash the light emission areas corresponding to positions of the static three-dimensional objects sequentially from a far side to a near side.

An aspect of the disclosure provides an information presentation device. The information presentation device includes a light emitter and circuitry. The light emitter is disposed in front of a driver's seat and includes light emission areas arranged along a width direction of a vehicle. The circuitry is configured to detect static three-dimensional objects ahead of the vehicle. The circuitry is configured to flash the light emission areas corresponding to positions of the static three-dimensional objects sequentially from a far side to a near side.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 illustrates a layout around a driver's seat of a vehicle;

FIG. 2 is a block diagram illustrating the configuration of the vehicle;

FIG. 3 is a block diagram illustrating the functional configuration of an information presentation ECU;

FIG. 4 illustrates an example of a situation ahead of the vehicle;

FIG. 5 illustrates an example of a grid map;

FIG. 6 illustrates detection of a road surface, dynamic three-dimensional objects, and static three-dimensional objects;

FIG. 7 illustrates a radial grid map;

FIG. 8 illustrates temporal changes in flashing modes of a light bar;

FIG. 9 illustrates temporal changes in the flashing modes of the light bar when there is a three-dimensional object having a collision risk;

FIG. 10 is a flowchart illustrating a flow of a light bar flashing control process;

FIG. 11 is a flowchart illustrating a flow of a road surface detection process;

FIG. 12 is a flowchart illustrating a flow of a dynamic three-dimensional object detection process;

FIG. 13 is a flowchart illustrating a flow of a static three-dimensional object detection process;

FIG. 14 is a flowchart illustrating a flow of a radial grid map generation process;

FIG. 15 is a flowchart illustrating a flow of a light bar information generation process;

FIG. 16 is a state transition diagram of the vehicle;

FIG. 17 illustrates an example of a notification image;

FIG. 18 illustrates examples of the notification image;

FIG. 19 illustrates a display example of an information display in a modification; and

FIG. 20 illustrates a display example of the information display in a modification.

### DETAILED DESCRIPTION

In the related-art vehicle, the driver can grasp the state of a moving object by flashing the light emission display, but may be unable to grasp the state of a static object. Therefore, there is room for improvement to allow the driver to sufficiently grasp the surrounding situation.

It is desirable that the driver easily grasp the surrounding situation.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### 1. Configuration of Vehicle 1

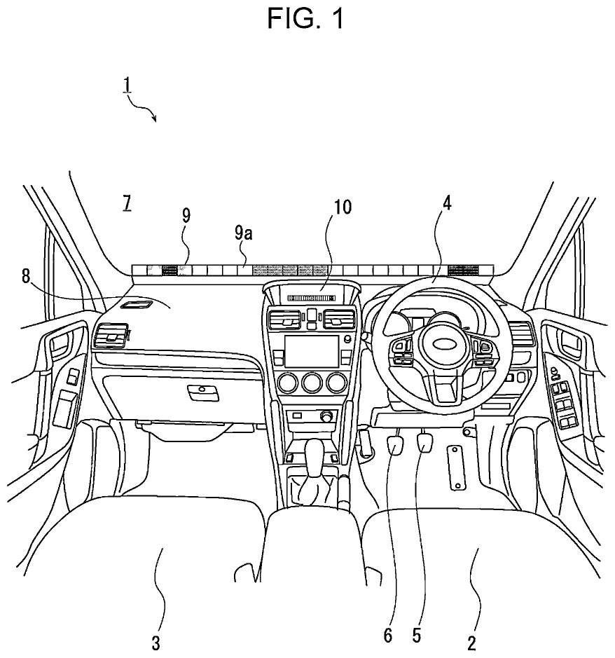

FIG. 1 illustrates a layout around a driver's seat 2 of a vehicle 1. As illustrated in FIG. 1, the driver's seat 2 and a passenger's seat 3 of the vehicle 1 are arranged in a width direction of the vehicle 1. The width direction of the vehicle 1 is hereinafter referred to simply as “width direction.”

The vehicle 1 includes a steering wheel 4 in front of the driver's seat 2, and an accelerator pedal 5 and a brake pedal 6 below the steering wheel 4.

The vehicle 1 includes a dashboard 8 in front of the driver's seat 2 and the passenger's seat 3 and below a windshield 7. The dashboard 8 is disposed along the width direction.

A light bar 9 is disposed above the dashboard 8 to overlap a lower part of the windshield 7. The light bar 9 is disposed along the width direction and has substantially the same length as the length of the windshield 7 in the width direction.

Thus, the light bar 9 is constantly visible at the lower part of the windshield 7.

In FIG. 1, 24 light emitters 9a of the light bar 9 are one-dimensionally arranged along the width direction. Each light emitter 9a has a rectangular or square shape and can emit light by a full-color light emitting diode (LED) in any light emission mode (color, brightness, light emission pattern, etc.). In one embodiment, the light emitter 9a may serve as a light emission area.

As described in detail later, the light bar 9 can notify a driver in a light emission mode about the state of a three-dimensional object ahead of the vehicle 1 (dynamic three-dimensional object or static three-dimensional object).

The light bar 9 may include a large number of light emitters 9a arranged in the width direction so that the driver can recognize the light emitters 9a without distinguishing them. In this case, the driver can recognize the light bar 9 as if the flashing areas (light emission areas) were seamless.

An information display 10 is disposed at the center in the width direction and below the light bar 9. The information display 10 is a liquid crystal display, an organic EL display, etc. and can provide the driver with images showing various types of information.

The information display 10 may be disposed at any position as long as it is visible to the driver. For example, the information display 10 may be a head-up display that displays an image on the windshield 7 in front of the driver's seat 2.

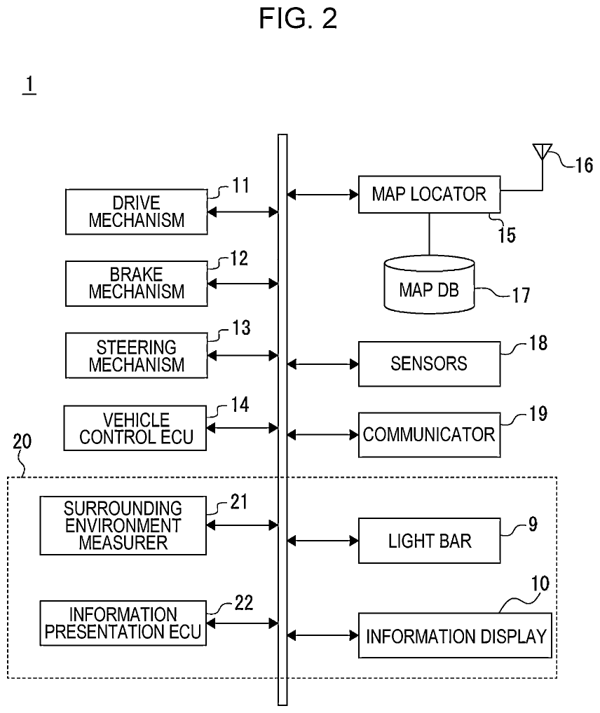

FIG. 2 is a block diagram illustrating the configuration of the vehicle 1. As illustrated in FIG. 2, the vehicle 1 includes a drive mechanism 11, a brake mechanism 12, a steering mechanism 13, a vehicle control electronic control unit (ECU) 14, a map locator 15, a global navigation satellite system (GNSS) receiver 16, a map database 17, sensors 18, a communicator 19, and an information presentation device 20 that are coupled via a bus.

The information presentation device 20 includes a surrounding environment measurer 21, an information presentation ECU 22, the light bar 9, and the information display 10.

The information presentation device 20 may include, for example, the map locator 15, the GNSS receiver 16, the map database 17, the sensors 18, and the communicator 19 in addition to the above components.

The vehicle control ECU 14 and the information presentation ECU 22 are constructed by different hardware components, but may be constructed by the same hardware component. Each of the vehicle control ECU 14 and the information presentation ECU 22 may be constructed by multiple hardware components.

The drive mechanism 11 includes either or both of an engine and a motor generator that are power sources for causing the vehicle 1 to travel. The drive mechanism 11 drives the vehicle 1 to travel. The drive mechanism 11 may include a transmission.

The brake mechanism 12 includes frictional brakes such as disc brakes, drum brakes, or powder brakes. The brake mechanism 12 generates braking forces for stopping rotation of wheels by generating frictional forces with hydraulic pressures, electromagnetic forces, etc.

The steering mechanism 13 includes devices related to steering, such as a power steering motor.

The vehicle control ECU 14 is a computer that controls traveling of the vehicle 1. The vehicle control ECU 14 controls operations of the drive mechanism 11, the brake mechanism 12, and the steering mechanism 13.

For example, the vehicle control ECU 14 determines a target torque based on a depression amount of the accelerator pedal 5 and a speed of the vehicle 1, and controls the drive mechanism 11 to output the determined target torque.

The vehicle control ECU 14 determines a brake amount (braking amount) based on a depression amount of the brake pedal 6, and controls the brake mechanism 12 to obtain the determined brake amount.

The vehicle control ECU 14 determines a steering amount (steering angle) based on an operation amount of the steering wheel 4, and controls the steering mechanism 13 to obtain the determined steering amount.

The vehicle control ECU 14 can execute autonomous driving for controlling the drive mechanism 11, the brake mechanism 12, and the steering mechanism 13 as appropriate so that the vehicle 1 can continue to travel appropriately while the driver is not operating the steering wheel 4, the accelerator pedal 5, and the brake pedal 6 (the driver is not involved in driving). In one embodiment, autonomous driving at level 3 is assumed but any other level may be adopted.

The map locator 15 calculates a current position (latitude and longitude) of the vehicle 1 based on satellite signals received by the GNSS receiver 16. The map locator 15 determines the current position of the vehicle 1 on a map by referring to map data stored in the map database 17. For example, the map locator 15 can determine a traveling lane in addition to a road where the vehicle 1 is traveling.

The sensors 18 include various sensors and operators of the vehicle 1. Examples of the sensors 18 include a vehicle speed sensor that detects a speed of the vehicle 1, a rotation speed sensor that detects a rotation speed of a rotation shaft of the drive mechanism 11, an accelerator pedal sensor that detects a depression amount of the accelerator pedal 5, a steering angle sensor that detects a steering angle of the steering wheel 4, a yaw rate sensor that detects a yaw rate, a G sensor that detects an acceleration of the vehicle 1, a brake switch to be turned ON or OFF depending on whether the brake pedal 6 is operated, and a brake pedal sensor that detects a depression amount of the brake pedal 6.

The communicator 19 executes network communication, vehicle-to-vehicle (V2V) communication, and road-to-vehicle communication. The vehicle control ECU 14 and the information presentation ECU 22 can acquire various types of information received by the communicator 19. The communicator 19 can acquire various types of information such as surrounding environment information, road information, and weather information of a current location by communication via a network such as the Internet.

The surrounding environment measurer 21 is a device that measures a surrounding environment of the vehicle 1. The surrounding environment measurer 21 includes one or more of, for example, a stereo camera that can capture an image of an area ahead of the vehicle 1, a radar device such as a millimeter wave radar or a laser radar, and a light detection and ranging (LiDAR) sensor. The surrounding environment measurer 21 may be any other device as long as the surrounding environment of the vehicle 1 can be recognized.

The surrounding environment measurer 21 calculates three-dimensional positions of objects ahead of the vehicle 1 (including a road surface) as point cloud data (hereinafter referred to as “three-dimensional point cloud data”), and outputs the calculated three-dimensional point cloud data to the information presentation ECU 22.

For example, the surrounding environment measurer 21 including the stereo camera calculates a three-dimensional position of each pixel by a so-called stereo method based on images captured by two cameras disposed away from each other. Thus, the surrounding environment measurer 21 can calculate the three-dimensional position of each pixel in the captured images as the three-dimensional point cloud data.

The surrounding environment measurer 21 including the radar device radiates a radio wave ahead of the vehicle 1 and measures the reflected wave to measure the distance and direction to a point where the radio wave is reflected. The surrounding environment measurer 21 calculates a three-dimensional position of the point where the radio wave is reflected based on the distance and direction measured by the radar device. Thus, the surrounding environment measurer 21 can calculate the three-dimensional position of each point where the radio wave is reflected, that is, an object ahead of the vehicle 1, as the three-dimensional point cloud data.

The information presentation ECU 22 is a computer that controls flashing of the light bar 9 and displaying on the information display 10 based on the three-dimensional point cloud data acquired from the surrounding environment measurer 21.

Description is mainly made about control on flashing of the light bar 9 and displaying on the information display 10 during the autonomous driving.

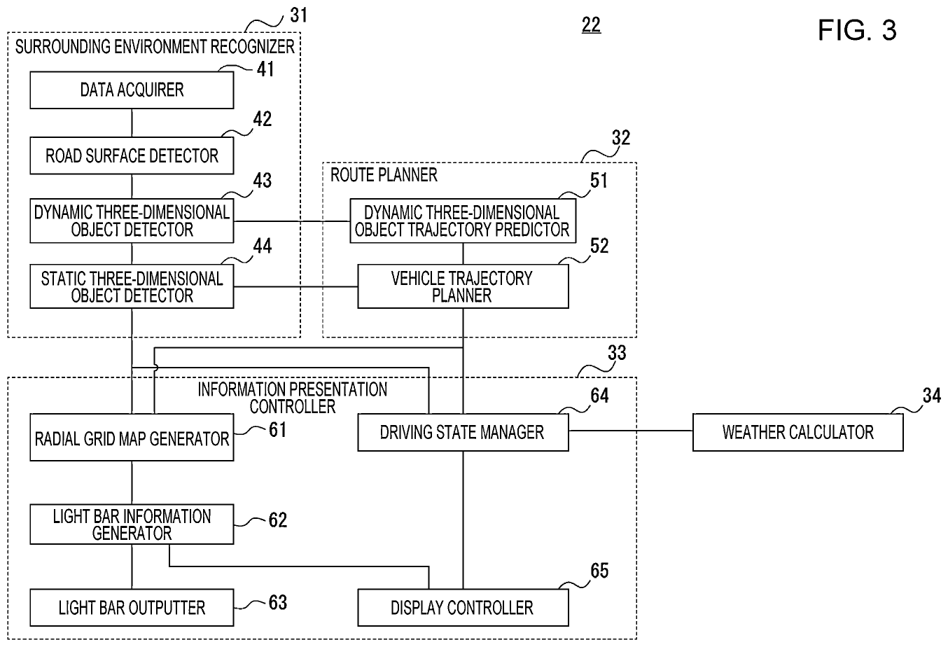

FIG. 3 is a block diagram illustrating the functional configuration of the information presentation ECU 22. As illustrated in FIG. 3, the information presentation ECU 22 serves as a surrounding environment recognizer 31, a route planner 32, an information presentation controller 33, and a weather calculator 34 during the control on flashing of the light bar 9 and displaying on the information display 10.

The surrounding environment recognizer 31 acquires three-dimensional point cloud data from the surrounding environment measurer 21, and recognizes a surrounding environment of the vehicle 1 based on the acquired three-dimensional point cloud data. The surrounding environment recognizer 31 serves as a data acquirer 41, a road surface detector 42, a dynamic three-dimensional object detector 43, and a static three-dimensional object detector 44.

The surrounding environment may include three-dimensional objects (static three-dimensional objects and dynamic three-dimensional objects) and a road surface around the vehicle 1.

The static three-dimensional object is an immovable three-dimensional object such as a side wall or a traffic light. The dynamic three-dimensional object is a movable three-dimensional object such as an automobile, a motorcycle, a bicycle, or a person.

The data acquirer 41 acquires three-dimensional point cloud data from the surrounding environment measurer 21.

The road surface detector 42 detects a road surface based on the three-dimensional point cloud data acquired by the data acquirer 41.

The dynamic three-dimensional object detector 43 detects a dynamic three-dimensional object based on the three-dimensional point cloud data acquired by the data acquirer 41.

The static three-dimensional object detector 44 detects a static three-dimensional object based on the three-dimensional point cloud data acquired by the data acquirer 41.

Specific processes of these functional components are described later.

The route planner 32 predicts a trajectory of a dynamic three-dimensional object and plans a trajectory of the vehicle 1. The route planner 32 serves as a dynamic three-dimensional object trajectory predictor 51 and a vehicle trajectory planner 52.

The dynamic three-dimensional object trajectory predictor 51 predicts a future trajectory of the dynamic three-dimensional object detected by the dynamic three-dimensional object detector 43 based on a temporal movement trajectory of the dynamic three-dimensional object.

The vehicle trajectory planner 52 plans a trajectory of the vehicle based on the trajectory of the dynamic three-dimensional object predicted by the dynamic three-dimensional object trajectory predictor 51, the position of the static three-dimensional object detected by the static three-dimensional object detector 44, etc.

Specific processes of these functional components are described later.

The information presentation controller 33 controls flashing of the light bar 9 and displaying on the information display 10. The information presentation controller 33 serves as a radial grid map generator 61, a light bar information generator 62, a light bar outputter 63, a driving state manager 64, and a display controller 65. The radial grid map generator 61 associates the presence or absence of a dynamic three-dimensional object or a static three-dimensional object with each cell of a radial grid map described in detail later.

The light bar information generator 62 generates light emission information for flashing the light bar 9 in a predetermined light emission mode (color, brightness, flashing pattern) based on the radial grid map generated by the radial grid map generator 61.

The light bar outputter 63 outputs the light emission information generated by the light bar information generator 62 to the light bar 9, and flashes the light bar 9 in the light emission mode indicated by the light emission information.

When a predetermined condition is satisfied, the driving state manager 64 makes transition to a driving state corresponding to the satisfied condition among multiple driving states. When determination is made that the autonomous driving cannot be continued, the driving state manager 64 terminates the autonomous driving and hands over the driving to the driver. The driving states are described later.

The display controller 65 controls displaying on the information display 10 based on the driving state managed by the driving state manager 64 and the light emission information generated by the light bar information generator 62. For example, the display controller 65 causes the information display 10 to display the condition determined by the driving state manager 64 and simulatively display the light bar 9 based on the light emission information.

Specific processes of these functional components are described later.

The weather calculator 34 calculates weather on a road where the vehicle 1 is traveling based on a current position of the vehicle 1 and weather information acquired via the communicator 19.

### 2. Control on Flashing of Light Bar 9 During Autonomous Driving

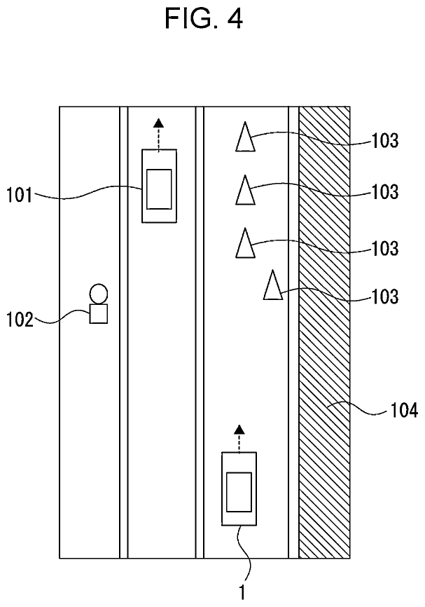

Description is made about the control on flashing of the light bar 9 during the autonomous driving taking a specific example. FIG. 4 illustrates an example of a situation ahead of the vehicle 1. Description is made about the control on flashing of the light bar 9 in the situation illustrated in FIG. 4.

As illustrated in FIG. 4, another vehicle 101 is traveling on the left side ahead of the vehicle 1, a pedestrian 102 is present on the left side ahead of the vehicle 1, cones 103 are present on a road (traveling lane) ahead of the vehicle 1, and a side wall 104 extends along the traveling direction on the right side of the vehicle 1. The pedestrian 102 is located closer to the vehicle 1 than is the other vehicle 101.

In this situation, the data acquirer 41 acquires three-dimensional point cloud data as needed from the surrounding environment measurer 21. The data acquirer 41 outputs the acquired three-dimensional point cloud data to the road surface detector 42.

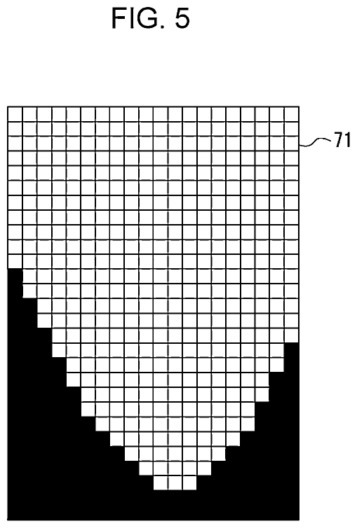

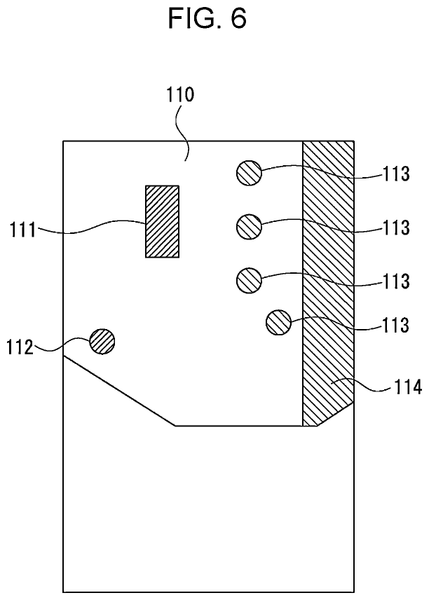

FIG. 5 illustrates an example of a grid map 71. FIG. 6 illustrates detection of a road surface, dynamic three-dimensional objects, and static three-dimensional objects.

The road surface detector 42 executes bird's eye view conversion by compressing each point in the three-dimensional point cloud data in terms of the position in a height direction. In the grid map 71 including square cells as illustrated in FIG. 5, the road surface detector 42 allocates (polls) each point obtained by the bird's eye view conversion to any cell based on the two-dimensional (planar) position obtained by the bird's eye view conversion.

In FIG. 5, black cells indicate cells that cannot be recognized by the surrounding environment measurer 21. Therefore, the points are not allocated to the black cells.

The road surface detector 42 calculates, for each cell, the height of the lowest point among one or more points in the cell as a minimum height (groundMinZ) of the cell. When the minimum heights (groundMinZ) of all the cells are calculated, the road surface detector 42 extracts, for each cell, points within a range from the minimum height (groundMinZ) to a height obtained by adding a predetermined value ε to the minimum height (groundMinZ). The predetermined value ε is set to any value within a range of, for example, 5 cm to 30 cm.

The point cloud extracted in this way is a point cloud corresponding to a road surface. Thus, the road surface detector 42 detects a road surface 110 by extracting the point cloud.

If there is no point corresponding to the road surface in one cell, a point corresponding to a three-dimensional object may be extracted but the ratio of such points to all the points is very small. Therefore, such points detected as the road surface have small effects.

When the point clouds corresponding to the road surface are extracted, the road surface detector 42 calculates an average of the heights of all the extracted point clouds as a road surface height (groundAvez).

The dynamic three-dimensional object detector 43 extracts point clouds by excluding the point clouds detected as the road surface from the point clouds in the three-dimensional point cloud data. The dynamic three-dimensional object detector 43 extracts, from the extracted point clouds, points within a range from a height obtained by adding a minimum three-dimensional object height (minDynObjZ) to the road surface height (groundAveZ) to a height obtained by adding a maximum three-dimensional object height (maxDynObjZ) to the road surface height (groundAvez) as point clouds of three-dimensional objects.

The minimum three-dimensional object height (minDynObjZ) is set to, for example, 30 cm and the maximum three-dimensional object height (maxDynObjZ) is set to, for example, 150 cm.

Thus, the point clouds within the range of 30 cm to 150 cm from the road surface are detected as point clouds of control target three-dimensional objects.

The detected point clouds have not yet been categorized into the dynamic three-dimensional object or the static three-dimensional object.

The dynamic three-dimensional object detector 43 detects dynamic three-dimensional objects using an algorithm for detection of dynamic three-dimensional objects, such as L-shape fitting, on the point clouds extracted as the three-dimensional objects, and estimates the coordinate positions, postures (orientations), and sizes of the detected dynamic three-dimensional objects.

As illustrated in FIGS. 4 and 6, the detected dynamic three-dimensional objects are a dynamic three-dimensional object 111 corresponding to the other vehicle 101 and a dynamic three-dimensional object 112 corresponding to the pedestrian 102.

The static three-dimensional object detector 44 removes the point clouds detected as the dynamic three-dimensional objects from the point clouds extracted as the three-dimensional objects, and extracts the remaining point clouds as point clouds of static three-dimensional objects.

The static three-dimensional object detector 44 detects each static three-dimensional object by joining the point clouds of static three-dimensional objects that have a short Euclidean distance using a nonlinear clustering algorithm such as DBSCAN on the extracted point clouds of static three-dimensional objects.

As illustrated in FIGS. 4 and 6, the detected static three-dimensional objects are static three-dimensional objects 113 corresponding to the cones 103 and a static three-dimensional object 114 corresponding to the side wall 104.

The dynamic three-dimensional object trajectory predictor 51 predicts trajectories of the dynamic three-dimensional objects 111 and 112 detected by the dynamic three-dimensional object detector 43 using an algorithm such as a Kalman filter based on time-series data of the coordinate positions, postures, and sizes of the dynamic three-dimensional objects 111 and 112.

The vehicle trajectory planner 52 plans a trajectory of the vehicle based on the trajectories of the dynamic three-dimensional objects 111 and 112 predicted by the dynamic three-dimensional object trajectory predictor 51, the positions of the static three-dimensional objects 113 and 114 detected by the static three-dimensional object detector 44, etc.

When the trajectories of the dynamic three-dimensional objects 111 and 112 predicted by the dynamic three-dimensional object trajectory predictor 51 and the planned trajectory of the vehicle are expected to overlap each other at the same time point, the vehicle trajectory planner 52 determines the dynamic three-dimensional objects as dynamic three-dimensional objects having a collision risk.

When the static three-dimensional objects 113 and 114 detected by the static three-dimensional object detector 44 and the planned trajectory of the vehicle are expected to overlap each other at the same time point, the vehicle trajectory planner 52 determines the static three-dimensional objects as static three-dimensional objects having a collision risk.

The vehicle trajectory planner 52 provides additional information indicating the collision risk at the nearest point to the dynamic three-dimensional object or the static three-dimensional object closest to the vehicle among the dynamic three-dimensional objects and the static three-dimensional objects having the collision risk.

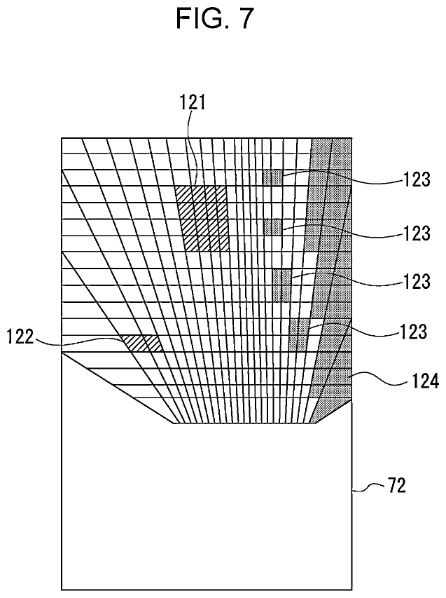

FIG. 7 illustrates a radial grid map 72. The radial grid map generator 61 generates, separately from the grid map 71, the radial grid map 72 including cells divided by grid lines radially drawn from a position corresponding to the position of the driver. That is, the radial grid map 72 is a map including cells radially expanding in conformity with the field of view of the driver. When the surrounding environment measurer 21 is a camera, the radial grid map 72 may be a map including cells radially expanding from the position of the surrounding environment measurer 21.

The radial grid map generator 61 associates the presence or absence of a dynamic three-dimensional object with each cell of the radial grid map 72 based on the coordinate positions, postures, and sizes of the dynamic three-dimensional objects 111 and 112 detected by the dynamic three-dimensional object detector 43. In FIG. 7, the cells associated with the dynamic three-dimensional objects 111 and 112 are hatched as dynamic three-dimensional object cells 121 and 122, respectively.

The radial grid map generator 61 associates the presence of a static three-dimensional object with each cell of the radial grid map 72 corresponding to the cell of the grid map 71 where the static three-dimensional object 113 or 114 is detected. In FIG. 7, the cells associated with the static three-dimensional objects 113 and 114 are dotted as static three-dimensional object cells 123 and 124, respectively.

The radial grid map generator 61 may associate the presence or absence of a static three-dimensional object with each cell of the radial grid map 72 based on the three-dimensional positions of the static three-dimensional objects 113 and 114 detected by the static three-dimensional object detector 44.

The number of cells of the radial grid map 72 in the lateral direction is equal to the number of the light emitters 9a of the light bar 9. The position on the radial grid map 72 in the lateral direction (e.g., the position from the left end) is associated with the position of the light emitter 9a of the light bar 9 in the width direction (e.g., the position from the left end).

Flashing of one corresponding light emitter 9a in the width direction is controlled based on the cells arranged in the longitudinal direction on the radial grid map 72.

That is, the presence or absence of the dynamic three-dimensional objects and the static three-dimensional objects that are two-dimensionally shown on the radial grid map 72 is represented as one-dimensional information on the light bar 9.

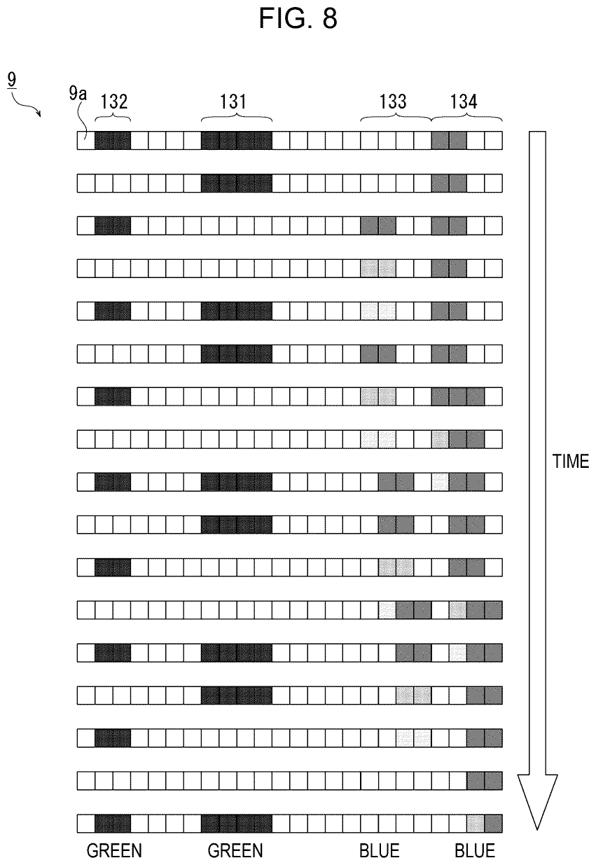

FIG. 8 illustrates temporal changes in flashing modes of the light bar 9.

When the dynamic three-dimensional object cell is present in the cells disposed along the longitudinal direction on the radial grid map 72, the light bar information generator 62 generates light emission information for blinking the corresponding light emitter 9a in the width direction at a blinking rate corresponding to a distance to the dynamic three-dimensional object cell closest to the vehicle 1 and in a color corresponding to the dynamic three-dimensional object (e.g., green). For example, the light bar information generator 62 generates the light emission information so that the blinking rate increases (blink period decreases) as the distance to the vehicle 1 decreases.

In this embodiment, as illustrated in FIG. 8, the light bar information generator 62 generates light emission information for blinking the light emitters 9a corresponding to the dynamic three-dimensional object cells 121 (light emission areas 131 in FIG. 8) in green. The light bar information generator 62 generates light emission information for blinking the light emitters 9a corresponding to the dynamic three-dimensional object cells 122 (light emission areas 132 in FIG. 8) in green and at a blinking rate higher than that in the light emission areas 131.

When the light emission information corresponding to the dynamic three-dimensional object is generated, the light bar information generator 62 outputs the generated light emission information to the light bar outputter 63. The light bar outputter 63 blinks the light bar 9 based on the input light emission information.

As illustrated in FIG. 8, the blinking rate is higher for the light emitters 9a corresponding to the position of the pedestrian 102 (light emission areas 132) closer to the vehicle 1 than is the other vehicle 101, and the blinking rate is lower for the light emitters 9a corresponding to the position of the other vehicle 101 (light emission areas 131) farther from the vehicle 1 than is the pedestrian 102.

The light bar information generator 62 generates light emission information for flashing the light emitters 9a corresponding to the positions of the static three-dimensional objects sequentially from the far side to the near side.

For example, the light bar information generator 62 detects whether a static three-dimensional object cell associated with the static three-dimensional object is present in a cell row (row in the lateral direction) farthest from the vehicle 1 on the radial grid map 72, that is, a cell row on the uppermost side in the longitudinal direction. When the static three-dimensional object cell is present, the light bar information generator 62 generates light emission information for flashing the light emitters 9a corresponding to the cell in a color corresponding to the static three-dimensional object (e.g., blue) and at a predetermined brightness value (1). The brightness value can be set within a range of 0 to 1, and is set to the maximum value of 1 in this case.

In the example of FIG. 8, the static three-dimensional object cells 124 corresponding to the side wall 104 are present in the cell row farthest from the vehicle 1. Therefore, the light bar information generator 62 generates light emission information for flashing the light emitters 9a corresponding to the static three-dimensional object cells 124 (light emission areas 134 in FIG. 8) in blue.

When the light emission information is generated, the light bar information generator 62 outputs the generated light emission information to the light bar outputter 63. The light bar outputter 63 flashes the light bar 9 based on the input light emission information. Thus, the light emitters 9a corresponding to the far side of the side wall 104 (light emission areas 134) are flashed in blue and at the maximum brightness.

After a predetermined period (several milliseconds) has elapsed, the light bar information generator 62 generates light emission information for flashing the light emitters 9a corresponding to the static three-dimensional object cells 124 in a cell row (row in the lateral direction) that is second farthest from the vehicle 1 on the radial grid map 72 in the color corresponding to the static three-dimensional object and at the brightness value (1) as in the farthest cell row, and outputs the light emission information to the light bar outputter 63.

Similarly, the light bar information generator 62 detects the static three-dimensional object cells sequentially from the cell row farthest from the vehicle 1 on the radial grid map 72 (uppermost cell row) and, when the static three-dimensional object cell is present, generates light emission information for flashing the light emitters 9a corresponding to the cell in a color corresponding to the static three-dimensional object and at the brightness value (1), and outputs the light emission information to the light bar outputter 63.

The light bar information generator 62 generates light emission information for flashing the light emitters 9a corresponding to the static three-dimensional object cells 123 and 124 in a cell row (row in the lateral direction) that is third farthest from the vehicle 1 on the radial grid map 72 in colors corresponding to the static three-dimensional objects and at the brightness value (1), and outputs the light emission information to the light bar outputter 63.

In this way, when the cone 103 approaches the vehicle 1, the light emitters 9a corresponding to the cone 103 (light emission areas 133 in FIG. 8) are flashed in blue and at the brightness value (1).

When the static three-dimensional object cell is detected in a cell row (row in the lateral direction) that is fourth farthest from the vehicle 1 on the radial grid map 72, the light bar information generator 62 does not detect the static three-dimensional object cells 123 detected in the third farthest cell row.

In this case, the light bar information generator 62 generates light emission information for flashing the light emitters 9a where the static three-dimensional object cells 123 are not detected at a brightness value attenuated by a predetermined attenuation factor (value smaller than 1).

When the static three-dimensional object cell is detected in a cell row (row in the lateral direction) that is fifth farthest from the vehicle 1 on the radial grid map 72, the light bar information generator 62 still does not detect the static three-dimensional object cells 123 detected in the third farthest cell row.

In this case, the light bar information generator 62 generates light emission information for flashing the light emitters 9a where the static three-dimensional object cells 123 are not detected at a brightness value further attenuated by the predetermined attenuation factor (value smaller than 1).

In this way, as illustrated in FIG. 8, the light emitters 9a corresponding to the farthest cone 103 (light emission areas 133) can be flashed while being dimmed gradually.

As illustrated in FIG. 8, the light emitters 9a corresponding to the side wall 104 disposed along the traveling direction on the right side of the vehicle 1 (light emission areas 134) are flashed in a sequence from the left side to the right side with time. That is, the light bar 9 can be flashed as if the light slid in the same direction as that of the shift of the line of sight of the driver who is viewing the static three-dimensional object disposed continuously along the traveling direction.

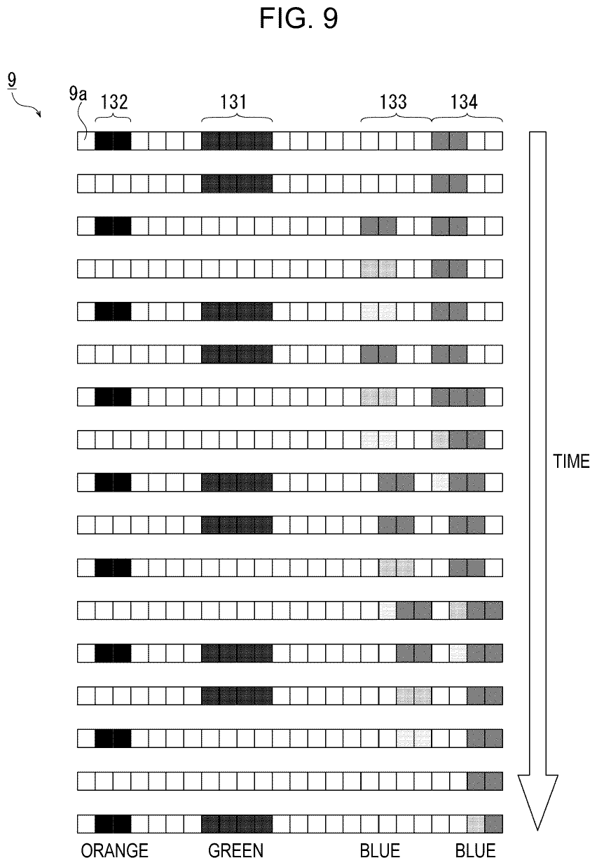

FIG. 9 illustrates temporal changes in the flashing modes of the light bar 9 when there is a three-dimensional object having a collision risk.

The above flashing modes of the light bar 9 are an example of the case where there is no three-dimensional object having a risk of collision with the vehicle 1. When there is a three-dimensional object having a risk of collision with the vehicle 1, the display modes of the light bar 9 differ from those in the case where there is no three-dimensional object having a collision risk.

Description is made taking an example in which the pedestrian 102 illustrated in FIG. 4 is moving toward the vehicle 1 and may collide with the vehicle 1. Since the display modes of the light emitters 9a corresponding to the other vehicle 101, the cones 103, and the side wall 104 having no risk of collision with the vehicle 1 are the same as those in the above case, the description is omitted.

When the pedestrian 102 may collide with the vehicle 1, additional information indicating the risk of collision with the vehicle 1 is provided to the dynamic three-dimensional object cells 122 corresponding to the pedestrian 102 on the radial grid map 72.

When the cell having the additional information indicating the collision risk is present in the cells disposed along the longitudinal direction on the radial grid map 72, the light bar information generator 62 generates light emission information for blinking the corresponding light emitters 9a (light emission areas 132 in this case) in a color (e.g., orange) different from the colors in the case of the static three-dimensional object and the dynamic three-dimensional object, and outputs the light emission information to the light bar outputter 63. The blinking rate is set higher than the blinking rate of the dynamic three-dimensional object.

The light bar outputter 63 controls flashing of the light bar 9 based on the input light emission information. Thus, as illustrated in FIG. 9, the driver can easily grasp the light emitters 9a corresponding to the pedestrian 102 having the risk of collision with the vehicle 1 (light emission areas 132).

### 3. Flashing Control Flow

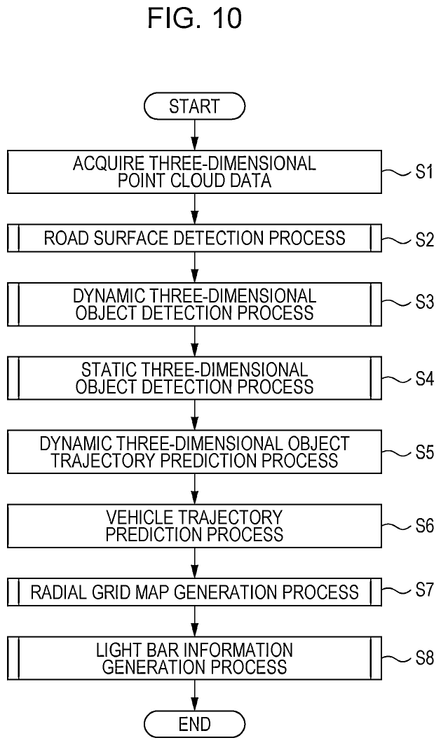

FIG. 10 is a flowchart illustrating a flow of a flashing control process for the light bar 9.

As illustrated in FIG. 10, when the flashing control process for the light bar 9 is started, the data acquirer 41 acquires three-dimensional point cloud data from the surrounding environment measurer 21 in Step S1. In Step S2, the road surface detector 42 executes a road surface detection process for detecting the road surface 110 based on the three-dimensional point cloud data.

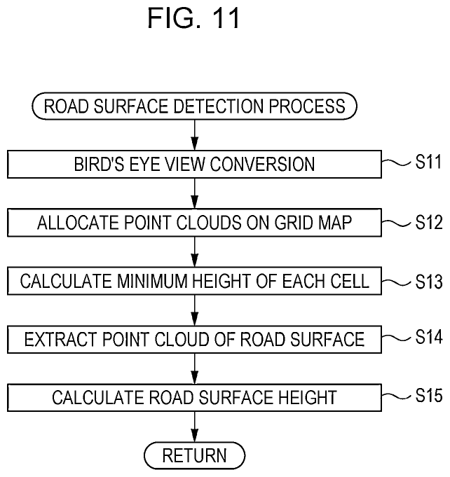

FIG. 11 is a flowchart illustrating a flow of the road surface detection process.

As illustrated in FIG. 11, when the road surface detection process is started, the road surface detector 42 executes, in Step S11, bird's eye view conversion by compressing each point in the three-dimensional point cloud data in terms of the position in the height direction. In Step S12, the road surface detector 42 allocates (polls) each point obtained by the bird's eye view conversion on the grid map 71 to any cell. In Step S13, the road surface detector 42 calculates, for each cell of the grid map 71, the height of the lowest point among one or more points in the cell as the minimum height (groundMinZ) of the cell. In Step S14, the road surface detector 42 extracts, for each cell, points within a range from the minimum height (groundMinZ) to a height obtained by adding the predetermined value ¿ to the minimum height (groundMinz) as a point cloud of the road surface 110. In Step S15, the road surface detector 42 calculates an average of the heights of all the extracted point clouds as the road surface height (groundAveZ), and terminates the road surface detection process.

Referring back to FIG. 10, the dynamic three-dimensional object detector 43 executes a dynamic three-dimensional object detection process for detecting dynamic three-dimensional objects in Step S3.

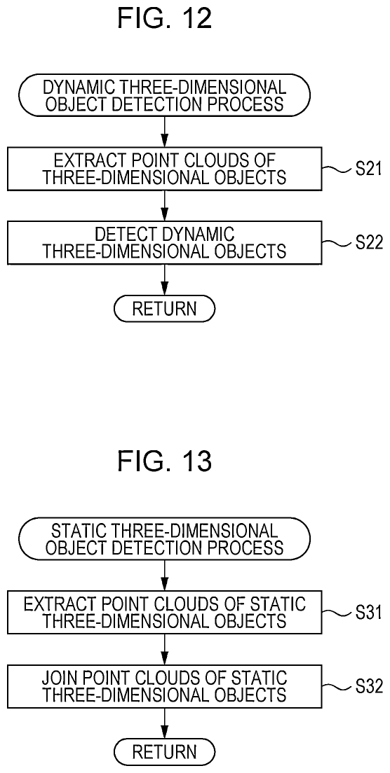

FIG. 12 is a flowchart illustrating a flow of the dynamic three-dimensional object detection process.

As illustrated in FIG. 12, when the dynamic three-dimensional object detection process is started, the dynamic three-dimensional object detector 43 extracts, in Step S21, point clouds by excluding the point clouds detected as the road surface from the point clouds in the three-dimensional point cloud data. The dynamic three-dimensional object detector 43 extracts, from the extracted point clouds, points within a range from a height obtained by adding the minimum three-dimensional object height (minDynObjZ) to the road surface height (groundAveZ) to a height obtained by adding the maximum three-dimensional object height (maxDynObjZ) to the road surface height (groundAvez) as point clouds of three-dimensional objects. In Step S22, the dynamic three-dimensional object detector 43 detects dynamic three-dimensional objects using an algorithm for detection of dynamic three-dimensional objects, such as L-shape fitting, on the extracted point clouds, estimates the coordinate positions, postures, and sizes of the detected dynamic three-dimensional objects, and terminates the dynamic three-dimensional object detection process.

Referring back to FIG. 10, the static three-dimensional object detector 44 executes a static three-dimensional object detection process for detecting static three-dimensional objects in Step S4.

FIG. 13 is a flowchart illustrating a flow of the static three-dimensional object detection process.

As illustrated in FIG. 13, when the static three-dimensional object detection process is started, the static three-dimensional object detector 44 removes, in Step S31, the point clouds detected as the dynamic three-dimensional objects from the point clouds detected as the three-dimensional objects, and extracts the remaining point clouds as point clouds of static three-dimensional objects. In Step S32, the static three-dimensional object detector 44 detects each static three-dimensional object by joining the point clouds of static three-dimensional objects that have a short Euclidean distance using a nonlinear clustering algorithm such as DBSCAN on the extracted point clouds of static three-dimensional objects, and terminates the static three-dimensional object detection process.

Referring back to FIG. 10, the dynamic three-dimensional object trajectory predictor 51 predicts, in Step S5, trajectories of the dynamic three-dimensional objects detected by the dynamic three-dimensional object detector 43 using an algorithm such as a Kalman filter based on time-series data of the coordinate positions, postures, and sizes of the dynamic three-dimensional objects.

In Step S6, the vehicle trajectory planner 52 plans a trajectory of the vehicle based on the trajectories of the dynamic three-dimensional objects predicted by the dynamic three-dimensional object trajectory predictor 51, the positions of the static three-dimensional objects detected by the static three-dimensional object detector 44, etc.

The vehicle trajectory planner 52 provides additional information indicating a collision risk at the nearest point to the dynamic three-dimensional object or the static three-dimensional object closest to the vehicle among the dynamic three-dimensional objects and the static three-dimensional objects having the collision risk.

In Step S7, the radial grid map generator 61 executes a radial grid map generation process for generating the radial grid map 72 and associating the presence or absence of a dynamic three-dimensional object or a static three-dimensional object with each cell.

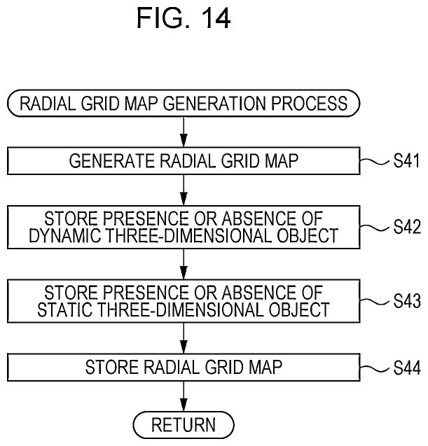

FIG. 14 is a flowchart illustrating a flow of the radial grid map generation process.

As illustrated in FIG. 14, when the radial grid map generation process is started, the radial grid map generator 61 generates the radial grid map 72 in Step S41. In Step S42, the radial grid map generator 61 associates the presence or absence of a dynamic three-dimensional object with each cell of the radial grid map 72 based on the coordinate positions, postures, and sizes of the dynamic three-dimensional objects detected by the dynamic three-dimensional object detector 43. In Step S43, the radial grid map generator 61 associates the presence of a static three-dimensional object with the cell of the radial grid map 72 corresponding to the cell of the grid map 71 where the static three-dimensional object is detected. In Step S44, the radial grid map generator 61 stores information on each cell of the radial grid map 72 in a predetermined storage, and terminates the radial grid map generation process.

Referring back to FIG. 10, the light bar information generator 62 executes a light bar information generation process for generating light emission information of the light bar 9 in Step S8.

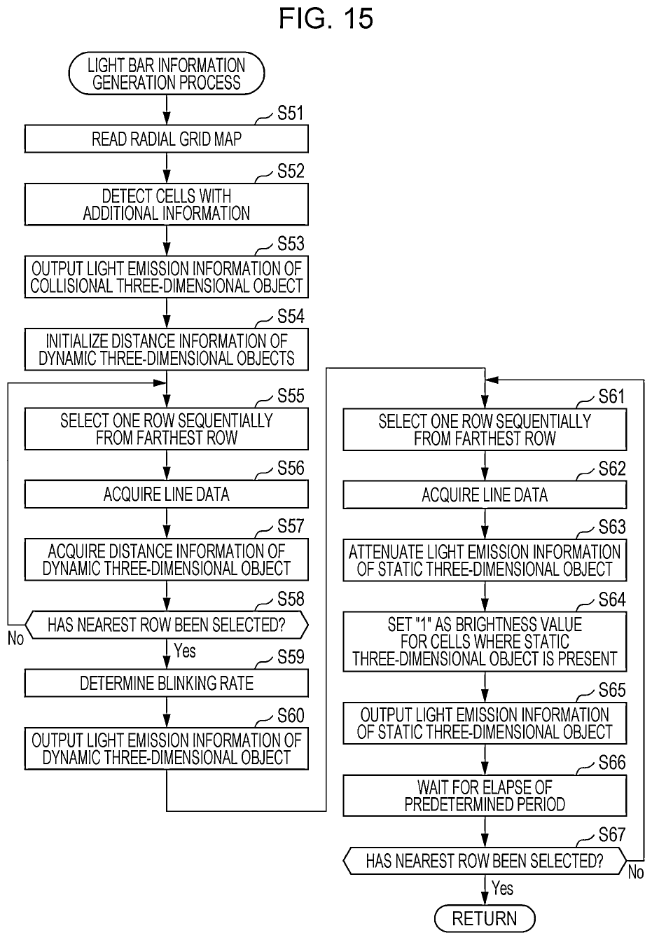

FIG. 15 is a flowchart illustrating a flow of the light bar information generation process.

As illustrated in FIG. 15, when the light bar information generation process is started, the light bar information generator 62 reads the radial grid map 72 in Step S51.

In Step S52, the light bar information generator 62 detects cells having the additional information indicating the collision risk. In Step S53, the light bar information generator 62 generates light emission information for blinking, in orange, the light emitters 9a corresponding to the cells having the additional information indicating the collision risk, and outputs the light emission information to the light bar outputter 63. Thus, the light bar outputter 63 blinks, in orange, the light emitters 9a corresponding to the cells having the additional information indicating the collision risk.

In Step S54, the light bar information generator 62 initializes the distance information of the dynamic three-dimensional objects corresponding to the light emitters 9a. In Step S55, the light bar information generator 62 selects one cell row sequentially from the farthest cell row on the radial grid map 72. In Step S56, the light bar information generator 62 acquires information (data) associated with the selected cell row. In Step S57, when there are cells where the dynamic three-dimensional object is present, the light bar information generator 62 acquires distances to the cells where the dynamic three-dimensional object is present, and sets distance information of the light emitters 9a corresponding to the cells. In Step S58, the light bar information generator 62 determines whether the nearest data row has been selected on the radial grid map 72. When the nearest data row has not been selected (No in Step S58), the process returns to Step S55. When the nearest data row has been selected (Yes in Step S58), the process proceeds to Step S59.

In Steps S55 to S58, the distance information of the nearest cell where the dynamic three-dimensional object is present is acquired in the longitudinal cell column corresponding to the light emitter 9a.

In Step S59, the light bar information generator 62 determines the blinking rate of the corresponding light emitters 9a based on the distance information acquired in Steps S55 to S58. In Step S60, the light bar information generator 62 generates light emission information for blinking the light emitters 9a corresponding to the dynamic three-dimensional object cells in green and at the determined blinking rate, and outputs the light emission information to the light bar outputter 63. Thus, the light bar outputter 63 blinks the light emitters 9a corresponding to the dynamic three-dimensional object in green.

In Step S61, the light bar information generator 62 selects one cell row sequentially from the farthest cell row on the radial grid map 72. In Step S62, the light bar information generator 62 acquires information (data) associated with the selected cell row. In Step S63, the light bar information generator 62 flashes the light emitters 9a corresponding to the static three-dimensional object at a brightness value attenuated by the predetermined attenuation factor (value smaller than 1).

In Step S64, the light bar information generator 62 sets “1” as the brightness value of the light emitters 9a corresponding to the cells where the static three-dimensional object is present. In Step S65, the light bar information generator 62 generates light emission information for flashing the corresponding light emitters 9a in blue and at the brightness value determined in Steps S63 and S64, and outputs the light emission information to the light bar outputter 63. Thus, the light bar outputter 63 flashes the light emitters 9a corresponding to the static three-dimensional object in blue.

In Step S66, the light bar information generator 62 waits for an elapse of a predetermined period. In Step S67, the light bar information generator 62 determines whether the nearest data row has been selected on the radial grid map 72. When the nearest data row has not been selected (No in Step S67), the process returns to Step S61. When the nearest data row has been selected (Yes in Step S67), the light bar information generation process is terminated.

### 4. State Transition

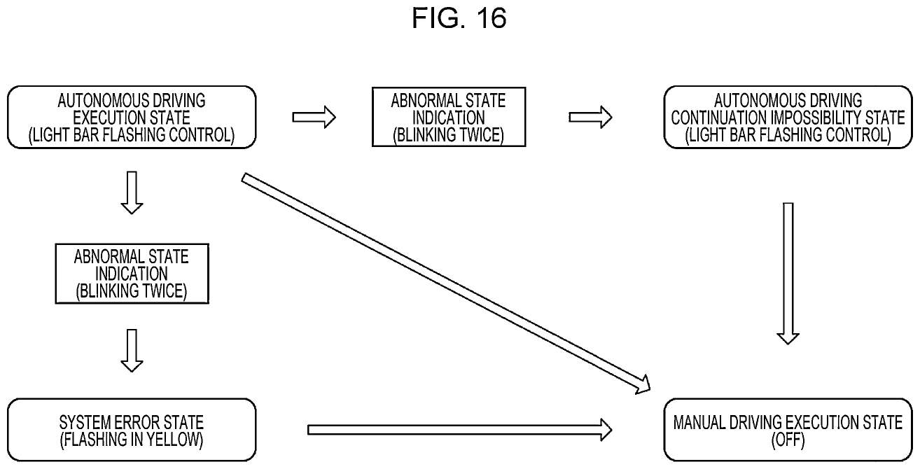

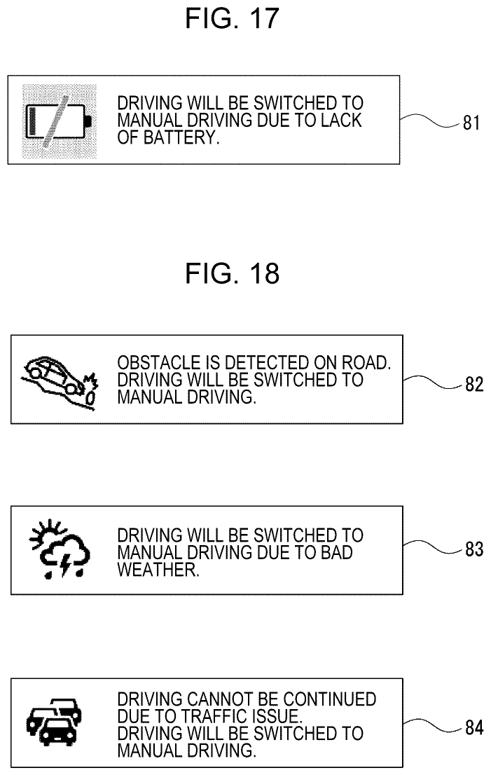

Description is made about transition of the driving state managed by the driving state manager 64. FIGS. 17 and 18 illustrate examples of a notification image. FIG. 16 is a state transition diagram of the vehicle 1. As illustrated in FIG. 16, the vehicle 1 has an autonomous driving execution state, an autonomous driving continuation impossibility state, a system error state, and a manual driving execution state.

The driving state manager 64 determines whether a driving state transition condition is satisfied based on the remaining battery charge level, the current position of the vehicle, the trajectories of the dynamic three-dimensional objects detected by the dynamic three-dimensional object detector 43, the static three-dimensional objects detected by the static three-dimensional object detector 44, the trajectory of the vehicle planned by the vehicle trajectory planner 52, etc. When the driving state transition condition is satisfied, the driving state manager 64 makes transition to the driving state corresponding to the satisfied condition.

In the autonomous driving execution state, the vehicle control ECU 14 is executing the autonomous driving. The driving state manager 64 makes transition to the autonomous driving execution state when the driver performs an operation for the autonomous driving and a condition under which the autonomous driving can be executed is satisfied.

While the autonomous driving execution state is set, the light bar information generator 62 and the light bar outputter 63 flash the light bar 9 in flashing modes corresponding to the dynamic three-dimensional objects and the static three-dimensional objects as described above.

When a predetermined prenotification condition is satisfied while the autonomous driving execution state is set, the display controller 65 causes the information display 10 to display a notification image corresponding to the satisfied prenotification condition.

The prenotification condition is a condition under which the autonomous driving cannot be continued in the near future or is not to be continued. Examples of the prenotification condition include a condition that the remaining battery charge level is equal to or lower than a predetermined value (e.g., 30%), a condition that the vehicle 1 approaches the exit of an expressway, a condition that the vehicle 1 enters an autonomous driving prohibition area, and a condition that the driver is prompted to have a rest due to the autonomous driving executed for a long period (e.g., 2 hours).

When any prenotification condition is satisfied, the display controller 65 causes the information display 10 to display a notification image corresponding to the satisfied prenotification condition with the flashing control continued for the light bar 9.

For example, when the remaining battery charge level is equal to or lower than the predetermined value, the display controller 65 causes the information display 10 to display a notification image 81 illustrated in FIG. 17. The notification image 81 shows that the autonomous driving will be terminated and switched to the manual driving due to lack of the remaining battery charge level.

When the prenotification condition is satisfied and then a condition under which the autonomous driving cannot be continued corresponding to the satisfied prenotification condition is satisfied, the vehicle control ECU 14 terminates the autonomous driving. Therefore, the driver promptly switches the driving to the manual driving when notified that the prenotification condition is satisfied.

When the driver switches the driving to the manual driving, the driving state manager 64 makes transition of the driving state to the manual driving execution state, and the vehicle control ECU 14 terminates the autonomous driving.

When the driver does not switch the driving to the manual driving and the condition under which the autonomous driving cannot be continued corresponding to the satisfied prenotification condition is satisfied, the driving state manager 64 may make transition of the driving state to, for example, the autonomous driving continuation impossibility state.

When a predetermined continuation impossibility condition is satisfied while the autonomous driving execution state is set, the driving state manager 64 makes transition of the driving state to the autonomous driving continuation impossibility state.

The continuation impossibility condition is a condition under which the autonomous driving cannot be continued and is to be terminated immediately. Examples of the continuation impossibility condition include a condition that there is an obstacle that the vehicle cannot steer around by the autonomous driving, a condition that roadwork is being conducted, a condition that the weather is bad due to heavy rain, dense fog, etc., and a condition that the vehicle is stuck due to road rage etc.

When the continuation impossibility condition is satisfied, the vehicle control ECU 14 safely stops the vehicle 1 after execution of so-called minimum risk maneuver.

The light bar information generator 62 and the light bar outputter 63 execute abnormal state indication by, for example, blinking all the light emitters 9a of the light bar 9 twice in yellow, thereby notifying the driver that the autonomous driving cannot be continued. Then, the light bar information generator 62 and the light bar outputter 63 control flashing of the light bar 9 again until the vehicle 1 is stopped.

When the predetermined continuation impossibility condition is satisfied while the autonomous driving execution state is set, the display controller 65 causes the information display 10 to display a notification image corresponding to the satisfied continuation impossibility condition.

For example, as illustrated in FIG. 18, when there is an obstacle that the vehicle cannot steer around, the display controller 65 causes the information display 10 to display a notification image 82. The notification image 82 shows that the autonomous driving will be terminated and switched to the manual driving due to the obstacle that the vehicle cannot steer around.

When the weather is bad, the display controller 65 causes the information display 10 to display a notification image 83. The notification image 83 shows that the autonomous driving will be terminated and switched to the manual driving due to the bad weather.

When the vehicle is stuck due to road rage etc., the display controller 65 causes the information display 10 to display a notification image 84. The notification image 84 shows that the autonomous driving will be terminated and switched to the manual driving because the vehicle is stuck due to road rage etc.

When a predetermined system error condition is satisfied while the autonomous driving execution state is set, the driving state manager 64 makes transition of the driving state to the system error state.

The system error condition is a condition under which the autonomous driving cannot be continued in any situation. Examples of the system error condition include malfunction in the sensors 18 or the surrounding environment recognizer 31, and an error in the control algorithm.

When the system error condition is satisfied, the vehicle control ECU 14 terminates the autonomous driving immediately. When the driver switches the driving to the manual driving, the driving state manager 64 makes transition of the driving state to the manual driving execution state.

When the system error condition is satisfied, the light bar information generator 62 and the light bar outputter 63 flash the light bar 9 in yellow after, for example, blinking all the light emitters 9a of the light bar 9 twice in yellow, thereby notifying the driver that the system error has occurred. Then, the light bar information generator 62 and the light bar outputter 63 continue to flash the light bar 9 in yellow until the driving is switched to the manual driving.

When the system error condition is satisfied while the autonomous driving execution state is set, the display controller 65 causes the information display 10 to display a notification image corresponding to the satisfied system error condition.

When transition of the driving state is made to the manual driving execution state, the light bar information generator 62 and the light bar outputter 63 terminate the control on flashing of the light bar 9. Thus, all the light emitters 9a of the light bar 9 are turned OFF.

### 5. Modifications

The above embodiment is an exemplary embodiment of the disclosure. The embodiment of the disclosure is not limited to the above example and various modifications are conceivable.

The display controller 65 may acquire light emission information from the light bar information generator 62 and display a simulative light bar 9 at an upper part of the information display 10 based on the acquired light emission information.

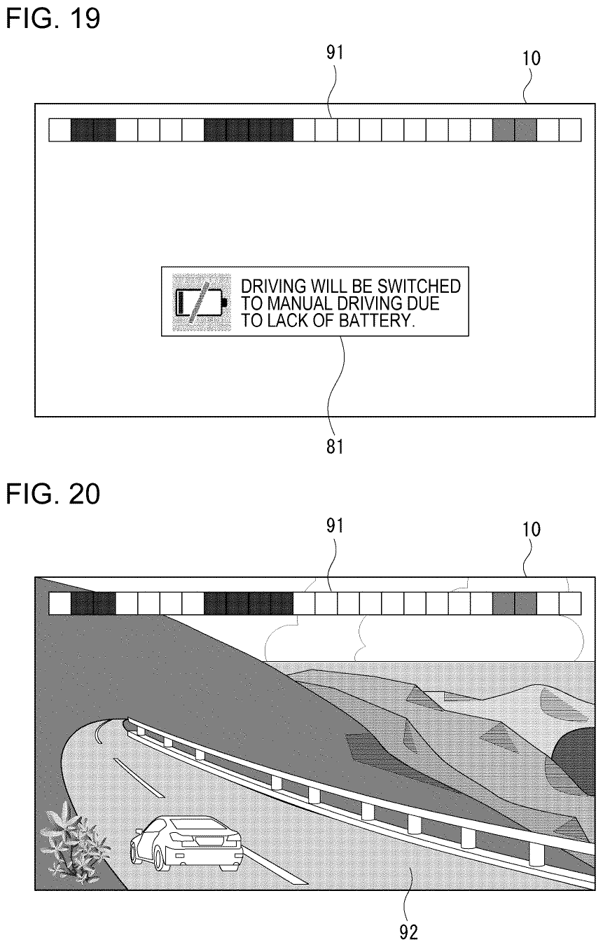

For example, as illustrated in FIG. 19, the display controller 65 causes the information display 10 to display an image 91 simulating the light bar 9. The display controller 65 may cause the information display 10 to display the image 91 simulating the light bar 9 together with the notification image 81, 82, 83, or 84.

Thus, the driver can grasp the surrounding situation by the image 91 simulating the light bar 9 at a timing when the driver views the information display 10.

As illustrated in FIG. 20, the display controller 65 may cause the information display 10 to display a predetermined content image 92 (e.g., a video on a video distribution website or a web browser image) and to display the image 91 simulating the light bar 9 so that the image 91 overlaps the content image 92.

Thus, the driver who is viewing the content image 92 can simultaneously grasp the surrounding situation by the image 91 simulating the light bar 9, and can be prompted to smoothly switch the driving to the manual driving.

The methods for detecting the road surface, the dynamic three-dimensional object, and the static three-dimensional object in the above embodiment are examples, and the road surface, the dynamic three-dimensional object, and the static three-dimensional object may be detected by other methods. For example, when the surrounding environment recognizer 31 is the stereo camera, the road surface, the dynamic three-dimensional object, and the static three-dimensional object may be detected by analyzing images captured by the stereo camera.

In the above embodiment, when there are multiple three-dimensional objects having a collision risk, the light emitters 9a corresponding to the three-dimensional object having a collision risk and closest to the vehicle 1 are blinked in orange. Based on predetermined priority levels instead of the distances to the vehicle 1, the light emitters 9a corresponding to a three-dimensional object having a collision risk and having the highest priority level may be blinked in orange. For example, the priority levels may be set in ascending order of a side wall, a fallen object, a vehicle, and a pedestrian.

In the above embodiment, the light emitters 9a corresponding to the dynamic three-dimensional object and the static three-dimensional object are selectively displayed depending on the blinking rate and color. However, the display modes of the light emitters 9a corresponding to the dynamic three-dimensional object and the static three-dimensional object are not limited as long as the distances and positions of the dynamic three-dimensional object and the static three-dimensional object can be grasped. For example, the brightness values of the light emitters 9a may be reduced as the dynamic three-dimensional object and the static three-dimensional object are located farther, or the light emission textures (light emission shapes) of the light emitters 9a may be varied depending on the types of the dynamic three-dimensional object and the static three-dimensional object.

### 6. Summary

As described above, the information presentation device 20 according to the embodiment includes the light emitter (light bar 9) disposed in front of the driver's seat 2 and including the light emission areas arranged along the width direction of the vehicle 1, the static three-dimensional object detector 44 configured to detect static three-dimensional objects ahead of the vehicle 1, and the information presentation controller 33 configured to flash the light emission areas (light emitters 9a) corresponding to the positions of the static three-dimensional objects sequentially from the far side to the near side.

Thus, the information presentation device 20 can flash, sequentially from the far side to the near side, the light emitters 9a at the positions where the static three-dimensional objects are present. That is, the information presentation device 20 can flash the light emitters 9a as if the light slid in the same direction as that of the shift of the field of view of the driver who is actually viewing the static three-dimensional objects. With the information presentation device 20, the driver can easily and intuitively grasp the surrounding situation.

The information presentation controller 33 is configured to, when the corresponding static three-dimensional object is no longer present, flash the light emission area (light emitter 9a) corresponding to the position of the static three-dimensional object at a brightness attenuated along with an elapse of time.

Thus, the information presentation device 20 can more clearly reproduce the shift of the field of view of the driver who is actually viewing the static three-dimensional objects. With the information presentation device 20, the driver can grasp the surrounding environment more easily.

The information presentation device 20 includes the dynamic three-dimensional object detector 43 configured to detect dynamic three-dimensional objects ahead of the vehicle 1. The information presentation controller 33 is configured to flash, in different light emission modes, the light emission areas (light emitters 9a) corresponding to the positions of the dynamic three-dimensional objects and the light emission areas (light emitters 9a) corresponding to the positions of the static three-dimensional objects.

With the information presentation device 20, the driver can easily grasp whether the three-dimensional object is the dynamic three-dimensional object or the static three-dimensional object.

The information presentation controller 33 is configured to blink the light emission areas (light emitters 9a) corresponding to the positions of the dynamic three-dimensional objects and flash the light emission areas (light emitters 9a) corresponding to the positions of the static three-dimensional objects.

With the information presentation device 20, the driver can clearly grasp the dynamic three-dimensional objects by blinking their positions, and can clearly grasp the static three-dimensional objects in a display mode similar to the shift of the field of view by flashing their positions as if the light slid.

The information presentation device 20 includes the display controller 65 configured to cause the display (information display 10) to display the predetermined content image 92 and to display the image 91 simulating the light emitter (light bar 9) so that the image 91 overlaps the content image 92.

With the information presentation device 20, the driver who is viewing the content image 92 can simultaneously grasp the surrounding situation by the image 91 simulating the light bar 9.

According to the embodiment of the disclosure, the driver can easily grasp the surrounding situation.

The information presentation ECU 22 illustrated in FIG. 3 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the information presentation ECU 22 including the surrounding environment recognizer 31, the route planner 32, the information presentation controller 33, and the weather calculator 34. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 3.

1. An information presentation device comprising:
a light emitter disposed in front of a driver's seat and comprising light emission areas arranged along a width direction of a vehicle;
a static three-dimensional object detector configured to detect static three-dimensional objects ahead of the vehicle; and
an information presentation controller configured to flash the light emission areas corresponding to positions of the static three-dimensional objects sequentially from a far side to a near side.

2. The information presentation device according to claim 1, wherein the information presentation controller is configured to, when any of the static three-dimensional objects is no longer present, flash one of the light emission areas corresponding to a position of the any of the static three-dimensional objects at a brightness attenuated along with an elapse of time.

3. The information presentation device according to claim 1, further comprising a dynamic three-dimensional object detector configured to detect dynamic three-dimensional objects ahead of the vehicle,
wherein the information presentation controller is configured to flash, in different light emission modes, the light emission areas corresponding to positions of the dynamic three-dimensional objects and the light emission areas corresponding to the positions of the static three-dimensional objects.

4. The information presentation device according to claim 3, wherein the information presentation controller is configured to blink the light emission areas corresponding to the positions of the dynamic three-dimensional objects and flash the light emission areas corresponding to the positions of the static three-dimensional objects.

5. The information presentation device according to claim 1, further comprising a display controller configured to cause a display to display a predetermined content image and to display an image simulating the light emitter so that the image simulating the light emitter overlaps the content image.

6. An information presentation device comprising:
a light emitter disposed in front of a driver's seat and comprising light emission areas arranged along a width direction of a vehicle; and
circuitry configured to
detect static three-dimensional objects ahead of the vehicle, and
flash the light emission areas corresponding to positions of the static three-dimensional objects sequentially from a far side to a near side.
